(19) United States
(12) Patent Application Publication
(10) Pub. No.: US 2025/0148931 A1
(43) Pub. Date: May 8, 2025

(54) SYSTEMS AND METHODS FOR ADAPTABLE PERSONALIZED EDUCATION

(71) Applicant: GEMS Education IPCO Holdings Limited, Abu Dhabi (AE)

(72) Inventors: Shameed Sait, Dubai (AE); Gopikrishnan Janakaraja, Dubai (AE); Sutharsan Chiranjeevi Partha Saarathy, Dubai (AE)

(21) Appl. No.: 18/386,784

(22) Filed: Nov. 3, 2023

(51) Int. Cl. G09B 19/00; G06N 20/00; G09B 5/06

(52) U.S. Cl. CPC G09B 19/00; G06N 20/00; G09B 5/06

(57) ABSTRACT

In accordance with the present disclosure, systems and methods are provided for providing personalized education to users. the systems and methods may collect, process, and analyze various user information including data from compatible IoT devices using a composite AI model. The systems and methods may generate a personalized education profile for the user using the composite AI model based on the analyzed user information. The systems and methods may generate and deliver personalized education content aided by the use of the composite AI model. the system may also monitor and receive user feedback in real-time for updating the composite AI model, the personalized education profile, and the personalized education content.

### TECHNICAL FIELD

The present disclosure relates to system and method for personalized education and in particular to the use of artificial intelligence (AI) for providing personalized education to one or more users.

### BACKGROUND

Traditional education often requires a single teacher to be responsible for the education of multiple students. Although class sizes may vary, teachers and by extension the education offered to the students are heavily limited by rigid and often outdated curriculums defined by overseeing entities such as an education board. As such, the education received by the student lacks flexibility. In fact, the academic progress of students may be hindered by less advanced students that the teacher may be required to accommodate. Moreover, as a result of limited time and other resources, teachers would be unable to adjust their lessons to specifically address the needs of individual students. That is, the education contents offered to each student is not tailored to their own strength and weaknesses. Moreover, having individual tutors or teachers is unrealistic due to costs and manpower. Further, even personal tutors would not have a holistic understanding of their students such that the best possible education is provided.

With the rise of digitalization, many new opportunities have been introduced. The education sector, being one such benefactor, has been transformed significantly. This process involves not just the digitalization of contents but also the delivery of such contents to students. Many platforms and modules have taken advantage of this advancement by providing websites or applications that enable students to receive education for topics of interests at their own pace.

Nevertheless, these digital platforms, such as traditional learning management systems (LMS) predominantly follow static content delivery methods similar to that of a traditional classroom. A typical education system may only comprise simple invariant algorithms that continuously offer further content as the student progress through the module. A more advanced platform may use algorithms to adjust the learning path based on a student's performance in assessments. However, these platforms typically focus on academic metrics and as such essentially only deliver content based on right or wrong answers. While effective for some students, they often don't take into account the broader context of the student's life or immediate emotional or physical state. Alternative platforms may incorporate functionalities that would allow teachers to design courses and track student performance. Nevertheless, these functionalities are only a supplement to the current education system and are inadequate to overcome many of the existing flaws such as lack of flexibility and adaptations for individual students. Although more recent iterations of these tools have incorporated certain features to personalize content, the level of customization is generally limited to course material organization, rather than taking consideration to the needs of the individual students.

Furthermore, with the rise of Internet of Things (IoT) devices, including smartwatches, wearables, and near-field communication (NFC) devices, there is an increased opportunity to capture granular data about students. These devices may be able to provide insights into physical activity, emotional states, and daily routines of students, all of which may impact their ability to learn and progress academically. However, existing educational tools have failed to tap into the potentials of IoT devices and their data collection capabilities. Programs and platforms that may be coupled to IoT devices are limited to implementations that are isolated cases of single purpose use (for example, the use of fitness trackers in physical education classes to monitor the activities of students), rather than boarder integration for personalized education by utilizing the capabilities of these devices.

In sum, these systems rely on predefined algorithms that are devoid of real-time adaptive learning functionalities. Further, said systems are heavily restricted by fixed algorithms and limited data input channels. As a result, their capacity to recognize and adapt to the diverse neural, cognitive, and emotional profiles of students is curtailed.

Accordingly, systems and methods that enable adaptive personalized education remains highly desirable.

### BRIEF DESCRIPTION OF THE DRAWINGS

Further features and advantages of the present disclosure will become apparent from the following detailed description, taken in combination with the appended drawings, in which:

FIG. 1 shows a representation of a system for providing adaptive personalized education;

FIGS. 2a and 2b show a design architecture and system engine pipeline of the personalized education system;

FIG. 3 shows a flow diagram for providing adaptive personalized education;

FIG. 4 shows a representation of the sourcing and integration of data for a system configured to provide adaptive personalized education;

FIG. 5 shows a flow diagram for holistically profiling users of a system configured to provide adaptive personalized education;

FIGS. 6a and 6b show flow diagrams for training and updating a composite AI model of a system configured to provide adaptive personalized education;

FIG. 7 shows a flow diagram for the model inference process of a composite AI model for a system configured to provide adaptive personalized education;

FIG. 8 shows a representation of the content personalization engine of a system configured to provide adaptive personalized education; and

FIG. 9 shows a representation of providing personalized education using a digital avatar.

It will be noted that throughout the appended drawings, like features are identified by like reference numerals.

### DETAILED DESCRIPTION

The present disclosure provides a system and method for delivering personalized education to students. The method and system may be implemented as a Web-based application with potential extensions as a standalone program or as an app for mobile and tablet devices. The system may be implemented as a cloud-based neural network system that ensures data integrity, scalability, and accessibility. With cloud integration, the system may be able to handle vast amounts of data from multiple sources without performance degradation.

Suitable application of the system and method of the present disclosure may include educational institutions. For example, primary and secondary schools may use the system and method of the present disclosure to provide personalized learning experience for each student, adjusting to individual strengths, weaknesses, and learning styles. As another example, universities and colleges may be able to implement the system of the present disclosure as adaptive course modules for specifics courses and particularly in online and blended learning scenarios. Further, institutions that cater to students with special needs can also utilize the adaptive features of the present disclosure to create customized learning pathways tailored to each student's unique challenges and strengths. Similarly, the system and method of the present disclosure may be implemented for tutoring services and corporate training programs. Individual tutors or tutor companies may use to the system to provide personalized sessions and identify the student's areas of weakness and strength in real-time. Companies may integrate the system into their existing training module or create a training module using the system to ensure that training is tailored to each employee's learning pace and style. E-learning platforms and MOOC providers may also integrity the system of the present disclosure with their own platform to provide course offerings with adaptive learning capabilities, which can lead to increased user engagement and course completion rates. Furthermore, individual learners may also use the system for a customized learning experience.

The system and method of the present disclosure may be able to receive enormous amounts of data associated with a student or user from a diverse variety of sources. In addition to collecting traditional academic metrics such as results of diagnostic tests, external assessment test, and academic examinations, the system of the present disclosure also collects non-academic data from a wide range of IoT devices and NFC devices such as smartwatches and wearable devices, that may be used by the students. The information obtained from the IoT or NFC devices may provide insights into the user's daily habits, physical activity levels, sleep patterns, and even emotional states, which may also the user's ability to learn. It would be appreciated that viewing these information as valuable data acknowledges that learning is not isolated from other aspects of a student's life; physical health, emotional well-being, and daily routines play crucial roles in the learning process.

These data are processed by a composite AI model which may comprise several different neural network/deep learning networks such as Convolutional Neural Networks (CNN), Recurrent Neural Networks (RNN), Deep Neural Networks (DNN), and Language Models (LLM). AIs and more specially Neural networks, inspired by the interconnected structure of human neurons, offer unparalleled capabilities in pattern recognition, data processing, and adaptability. Especially, Deep Learning architectures, such as CNN and RNN, can process multi-dimensional data, making them potent tools for educational personalization. Nonetheless, existing applications of AI in education is limited to measuring the perceived engagement (for example, by monitor student engagement by observing visual changes using webcam feeds) which is only used to determine the pacing of the delivery of education content and therefore also lack a holistic approach of combining this with academic performance and daily life metrics.

In contrast, the system of the present disclosure employ these AI models to cooperatively process the received user data into a personalized education profile for the user. The composite AI model can identify factors affecting the education of the user and further weigh and transform these factors into attributes in the education profile. By processing the wide range of data, the system may be able to produce a comprehensive and multi-dimensional education profile for the student. Further, the inclusion of both academic and non-academic data can greatly enhance the efficacy of the composite AI model. By leveraging both academic metrics and data from wearables, NFC devices, and IoT devices, the system may be able to consolidate a 360-degree view of the student in the form of the personalized profile, incorporating daily habits, physical well-being, and emotional states. The personalized profile could therefore offer a deeper, more comprehensive understanding of a student than traditional systems. As such, it may be possible to provide personalization that extends beyond academic performance to encompass the broader aspects of a student's life. It should be noted that the system and method of the present disclosure may be supported and enabled by the composite AI model. As such, the system may be referred to in the present disclosure as ANET, which represents that the model powering the system is an advanced network model.

By using the personalized profile as a guide, the system may be able to tailor the education content delivered to the user. the system may offer education content in the form of traditional lessons, tests, quizzes, or more advanced methods such as multimedia presentation, experiments, activities, and interactive simulations to the student that are based on the personalized profile. The system may factor in academic standing, learning preferences, and non-academic variables such as the student's current emotional state or physical energy levels to offer content in the format most conducive to the user's current situation. As such, the educational content may be delivered in a more preferable manner.

The system of the present disclosure may comprise the use of a digital avatar to better facilitate the delivery of educational content. The digital avatar may serve as an interactive companion for the student. In an effort to better connect with the students, certain digital platforms have incorporated the use digital or virtual avatars as lesson providers or assistants to guide and direct the users. However, while these avatars might respond based on student input such as response entry, the avatars are incapable of dynamically adjusting to real-time emotional, visual, or physical cues. Conversely, accordingly to the present disclosure, in order to better provide personalized content delivery, the avatar may adapt its teaching style, communication tone, and appearance based on the student's personalized profile. The system may also track real-time engagement using the collected user data, which may empower the avatar to identify shifts in a student's attention or mood, and thereby allowing it to better suit the needs of the student. For example, the avatar may be configured to introduce breaks, change content mediums, or integrate engaging activities to keep the learning process smooth and effective.

Since the user is not static, the personalized profile and by extension the delivered education content of the user may be constantly updated to reflect the current state of the user as to best provide personalized education. The user data described previously may be continuously collected, monitored, and updated. By processing the stream of data, the composite AI model may be able to constantly calibrate and update the user's personalized profile in real-time. That is, the system may ensure that the profile is always up-to-date by adapting to both academic milestones and changes in daily life such that as the user or student progresses, faces challenges, or undergoes changes in their routines, the composite AI model can recalibrates the learning environment to match their evolving needs and deliver suitable educational content. Contrary to traditional platforms that may provide sessional or periodic adjustments, the system according to the present disclosure may provide real-time tracking and to continuously refine and update the personalized profile. As such, the system may provide learning experience that remains relevant and tailored, regardless of changes in academic or personal contexts and that immediate adaptation to the provided education can be made based on any detected changes by the composite AI model, explicit or inferred.

The system may also use the continuous stream of collect data and feedback to the provided education to self-update the composite AI model in real-time. By incorporating a feedback loops that includes the response of the user, which may be direct or implicit, the system may be able to better understand the user's personality and needs such that the system can be more responsive and potentially be proactive in anticipating the needs of the user. Overall, while many traditional platforms operate in silos, the systems and methods of the present disclosure provides an integrated approach to ensure a cohesive, unified learning experience. Even further, in view of educational shifts and the advancement and deployment of new devices and modules, the system of the present disclosure may comprise a modular framework that allows for the incorporation of new modules, subjects, and topics as well as seamless integration with other educational platforms or tools to extend the reach of personalized.

Advantageously, by training and updating the composite AI model and by extension the delivered education content based on user data and feedback, the system of the present disclosure offers a one-size fits all learning solution tailored to each student or user's unique needs and context through comprehensive profiling of various different factors affecting their learning, from health to emotional well-being. By tapping into wearables, NFC devices and IoT devices, the system can adjust learning content based on a student's daily activities (for example, potentially suggesting study breaks after physical activities or offering calming content after a stressful day) and act on physical and emotional data in additional to academic data. The system may also provide the education using the digital avatar as a medium, which may also function as a emotional support tool, recognizing when students might be stressed or overwhelmed and offering strategies or breaks accordingly. Further, the composite AI model allow real-time adjustment to ensure that the student remain engaged and support at all times. With real-time monitoring and updates, the system can create dynamic learning paths that ensure students remain intrigued, challenged, and motivated, thus significantly reducing drop-off rates and better facilitate learning.

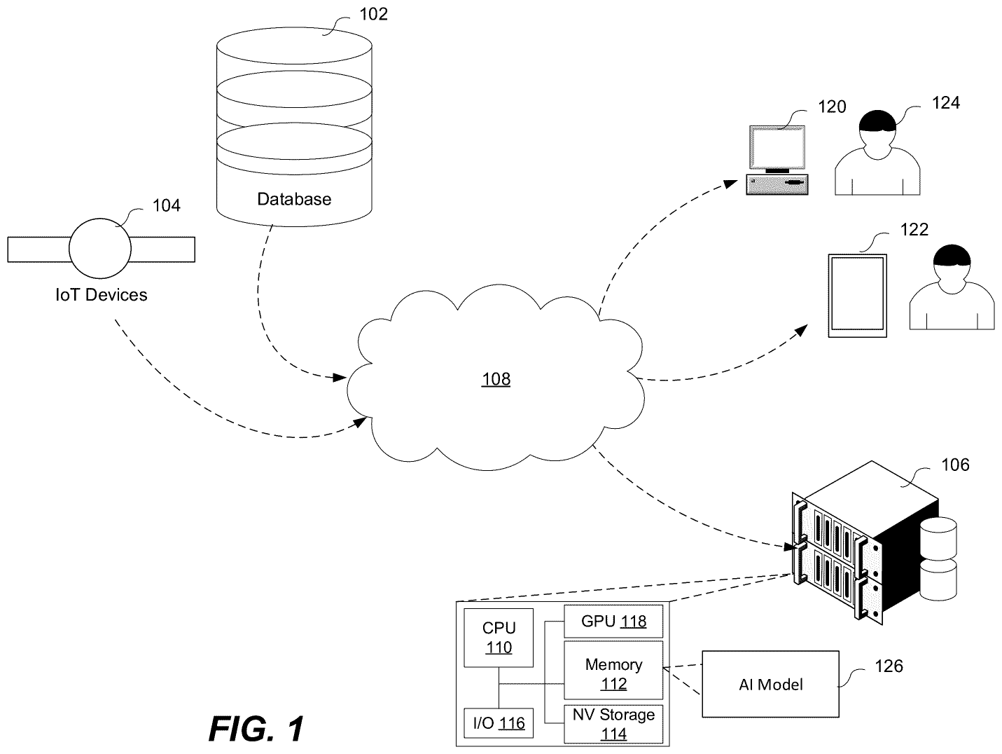

Embodiments are described below, by way of example only, with reference to FIGS. 1-9.

FIG. 1 shows a representation a system for providing adaptive personalized education. The system comprises one or more servers 106 communicatively coupled with data sources over communications network 108 (e.g. the Internet). Although the communication network is depicted as an internet network, it would be appreciated that other connections (e.g. wired, Bluetooth) are also possible. The data sources may be one or more IoT/NFC devices 104 (e.g. smart watch, cameras, wearables, etc.) or one or more databases 102 (e.g. online test results, academic records, content that was previously delivered, etc.). The IoT/NFC devices 104 are configured to capture and transmit data associated with one or more students or users 124 to the server 106. The data may be data related to the physical well-being (e.g. heart rate), emotional-welling, engagement level, response to delivered content and other non-academic information of the user 124. Similarly, the server 106 may also receive data associated with the user 124 from the one or more databases 102, with the data being academic information. In the context of the present disclosure, the term student and user may be used interchangeably and refers to the person for whom the education is provided for.

In accordance with the present disclosure, the systems and methods for providing personalized education are configured to receive and process the data associated with the user 124 received over the network 108. The data may be sorted, classified, weighted, and analyzed in order to best deliver suitable education to the users 124. The systems and methods of the present disclosure may analyze the user data as to provide or generate a personalized education based on the analysis to the users 124 based on their current state, including their academic knowledge and physical state, such that the personalized education is tailored to and most suitable for the users 124. As updated data is received, the system and method may update the provided personalized education in real-time. For example, the system and method may gauge the response of the user 124 and accordingly adjust the education provided to said user. To process the data and provide personalized education, the system and method may use one or more artificial intelligence (AI) models to analyze data and customize education or content being delivered the users 124. The content may be delivered from the server 106 over the network 108 to user devices, which may be for example, a computer 120, or a phone/tablet 122. Although not depicted, other user devices such as television, smartwatch, etc. may also be used as mediums for receiving personalized education. For ease of reception by user, the system and method may be implemented as a web-based application, standalone, program, or application such that the user 124 may be able to more easily view, listen, as well as respond to the personalized education. The user devices 120 122 may also be configured to transmit data such as user responses to the delivered content back to the server 102.

In a particular implementation, the servers 106 are configured to receive data associated with the user 124 from IoT/NFC devices 104 and databases 102. The servers 102 each comprise a CPU 110, a non-transitory computer-readable memory 112, a non-volatile storage 114, an input/output interface 116, and graphical processing units (“GPU”) 118. The non-transitory computer-readable memory 112 comprises computer-executable instructions stored thereon at runtime which, when executed by the CPU 110, configure the server to perform an method for providing personalized education as described in more detail herein. The non-volatile storage 114 has stored on it computer-executable instructions that are loaded into the non-transitory computer-readable memory 112 at runtime. The input/output interface 116 allows the server to communicate with one or more external devices (e.g. via network 108), including IoT/NFC devices 104 and databases 102, as well as to user devices 120 122. The non-transitory computer-readable memory 112 also comprises a composite artificial intelligence model 126 that is trained to process the received data. The processed data may be used by the AI model 126 to generate and tailor education content to the user 124. The AI model may also generate a personalized profile for the user 124 which may be used to better facilitate the generation and delivery of educational content. The GPU 118 may be used to control a display and may be used to run the artificial intelligence model provide personalized education based on the received data. In particular, the servers 102 may be high performance servers with significant GPU support from GPU 118 for neural network computations which may ensure that real-time processing and analytics occur without delay. When suitable education content has been determined by the AI model 126, the servers 102 may output the delivery content to the user devices 120 122. It will be appreciated that there may be multiple servers 102 implemented to perform the methods for providing individual personalized education to multiple different users 124. Multiple servers 102 may be networked together and collectively perform the anomaly detection method using distributed computing.

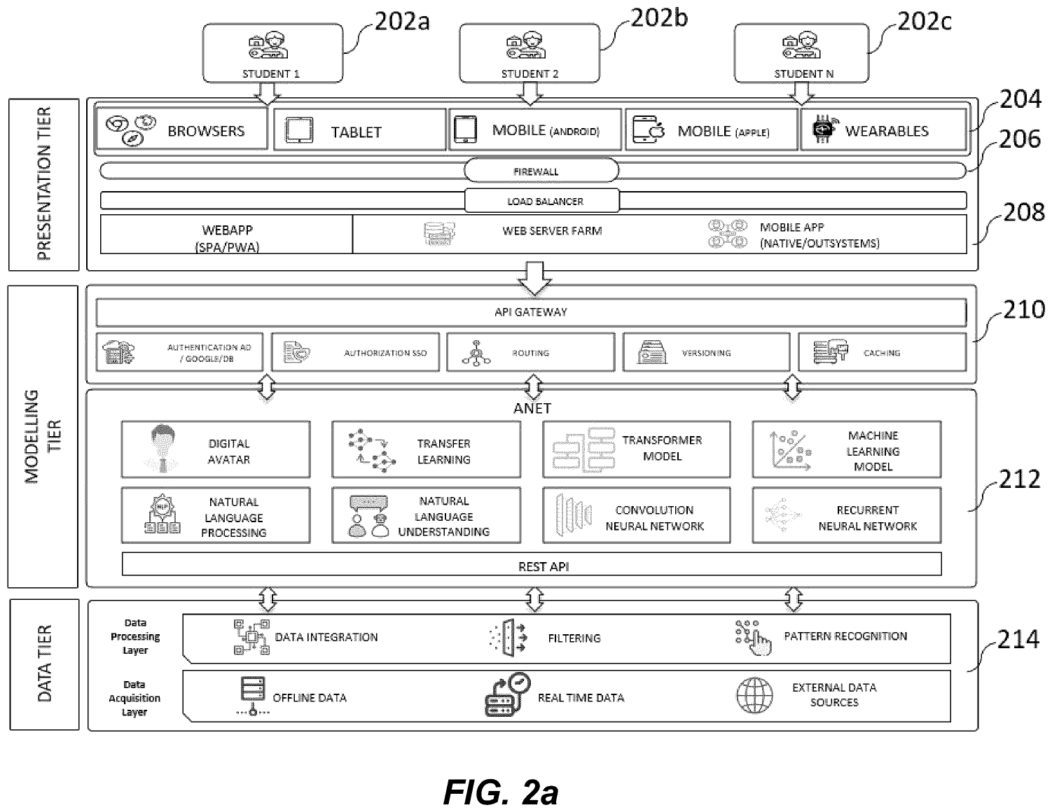

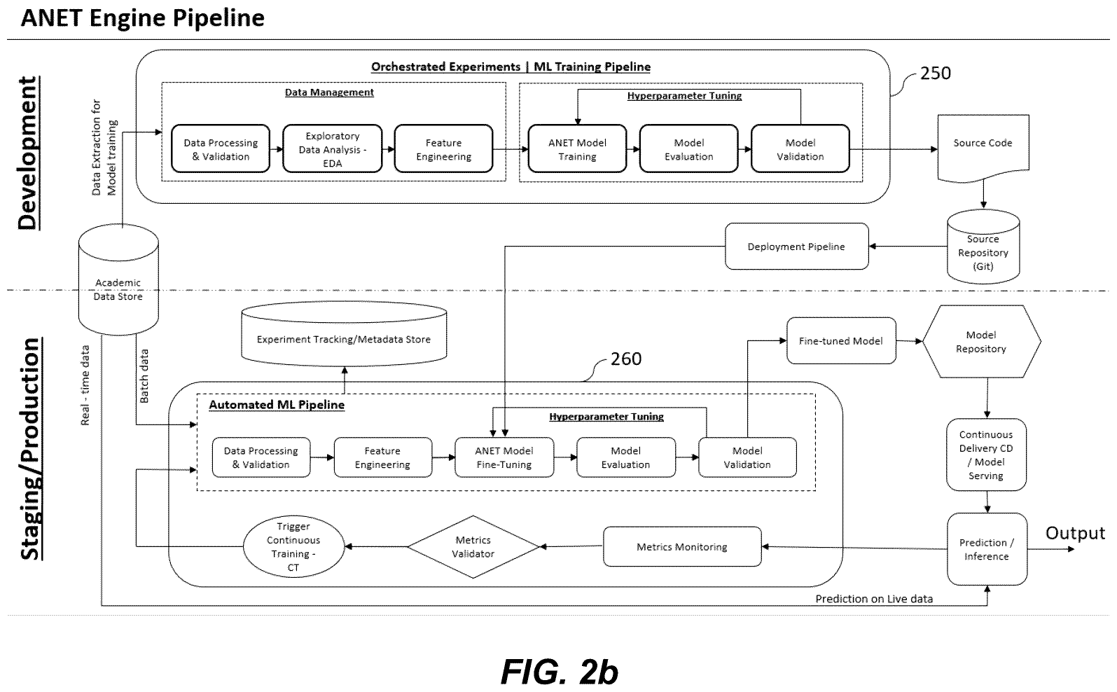

FIG. 2a is a visual representation of a general architecture of an embodiment of the system for providing personalized education according to the present disclosure. Users of the system, which may be students 202a, 202b, 202c, up to any number of students may interact with the system at a level classified as presentation tier, as depicted in FIG. 2a. The users 202a, 202b, 202c, may interact with the system through one or more devices or device interfaces 204 over a communication network. In some embodiments, this layer may be referred to as the frontend of the system. The presentation layer may be developed using frameworks like React or Angular, although other frameworks are also possible, to facilitate a responsive and dynamic user interface. The responsiveness and dynamic nature of the interface can be greatly beneficial for the real-time adaptability of the system. The devices 204 may comprise one or more of (but is not limited to): browsers (i.e. on a personal computer, TV, or smart whiteboard), tablets, mobile devices (operating with an Android or Apple system), wearables devices (i.e. smartwatch), and NFC devices. Each of the devices 204 may require slightly different implementation as constrained by the software and hardware requirements of each device. Using the devices 204 as mediums, the system of the present disclosure may provide personalized education to the users 202a, 202b, 202c. The personalized education may be one or more of lessons, quizzes, presentations, as will be described further herein. Simultaneously, the devices 204 may also be used for data collection and feedback reception purposes. For example, the devices 204 may receive and collect information for engagement tracking, monitoring of physical and emotional wellbeing in addition to student responses to provided questions, tests, and quizzes. The system may be optimized for compatibility with various devices ranging from PCs, tablets, and smartphones to specific IoT and wearable devices such that the system operates with minimal latency and conducts efficient data transfer.

A firewall 206 may also be implemented at this level/tier. The firewall 206 may be used for data security and encryption purposes. The firewall 206 may filter out spam and malicious data as well as ensure that the data transmitted between the system of the present disclosure and the devices 204 is protected. The transmitted data may also undergo load balancing to distribute the data traffic into different servers and components to enable more efficient data processing and lower response time. Load balancing may be used to spread data across different servers. This can facilitate the management of data traffic more quickly and reduces the time it takes to get a response. The data may be sorted into different sectors 208 comprising corresponding sections for web-app, webserver farm, and mobile app. More specifically, the web-app may refer to a front-end interface through which students can interact. This interface could be anything from a learning platform to a dashboard or a collaborative tool. The web server farm can operate behind a firewall and a load balancer. It acts as the backbone, serving both the web-app and mobile app, ensuring that requests are processed efficiently and data is delivered promptly to the users.

According to an embodiment of the present disclosure, the presentation layer of the personalized education system may interact with a modeling layer of the same system. The modeling tier may receive user data from the presentation layer through an API gateway 210, which can facilitate more effective and efficient data transfer and exchange. The data received through the API gateway 210 might go through several steps before it reaches the being processed by the core components of the personalized education system. These steps can include checking the user's identity with Active Directory or Google database, Single Sign-On Authentication (a simple way for users to log in), routing (directing the data to the right place), versioning (keeping track of different versions of data), and caching (storing data so it can be accessed quickly). These steps can keep the data safe, well-organized, and easy to manage. It would be appreciated that when data (for example, in the form of personalized content for the users) is transmitted from the main module 212 to the users 202a, 202b, 202c, the process described above is reversed to maintain data integrity, efficiency, and security in both directions. The main module 212 of the system of the present disclosure may comprise one or more modular components that may work cooperatively to provide personalized education. The modular components may include components responsible for and corresponding to: digital avatar, transfer learning, transformer model, machine learning model, natural language processing, natural language understanding, CNN, and RNN, which will be described further herein. The layer may to referred to as the backend of the system. programming code that defines, governs, and modifies the modeling layer may be primarily written using languages such as Python, although other computer languages are also possible and compatible. Further, the neural network operations at this layer may be facilitated by the use of machine learning libraries like TensorFlow and PyTorch.

According to an embodiment of the present disclosure, the system for providing personalized education may also comprise a data layer 214 coupled to the modeling layer. The two layers may exchange and transmit data between each other. The system may ensure anonymity for any data or information exchanged between the two layer by implementing representational state transfer architecture (REST) for API data exchange. The REST API may also be used for data integration between layers and other devices and databases. For example, the use of REST API may better facilitate integration with other educational platforms, tools, and wearable/IoT/NFC device data streams. The API utilized in the present disclosure may also be document to further improve integration with existing learning management systems and other education platform. The system of the present disclosure may also be implemented using standard or flexible API structure such a newly added devices (i.e. new IoT/NFC devices) can be made compatible and easily integrated. The data layer may comprise one or more component layers. One component layer may be a data processing later. The data processing layer may be configured to perform one or more of: data integration (i.e. from different external sources), data filtering (i.e. sorting), and pattern recognition. A data acquisition layer may also be implemented. The data acquisition layer may be configured to receive, process, and manage one or more of: offline data, real-time data, and data from external sources. The system may also employ a combination of relational databases (e.g., PostgreSQL) for structured data and NoSQL databases (e.g., MongoDB) for unstructured or semi-structured data, which may optimize data retrieval and storage operations.

FIG. 2b is a flow diagram that represents the engine pipeline of an embodiment of the system for providing personalized education according to the present disclosure. FIG. 2b depicts the pipeline as a feedback loop that constantly updates the AI composite model powering the system and updates the personalized education provided to the user. The system can be broadly interpreted to comprise two main core component pipelines: the model training pipeline 250 and the model inference pipeline 260. The system and method for training the AI model (training stage) of the present disclosure will be described in further detail herein. Model inference (prediction stage) refers to the use of the AI model to make educated guesses or extract patterns from new input data. For example, the AI model may provides real-time, personalized pedagogical insights and recommendations based on the data inputs from users. it would be also appreciated that the AI model(s) of the present disclosure may be optimized for operation/processing speed, by, for example, the use of high-performance computing clusters for parallel processing.

According to an embodiment of the present disclosure, the training of the composite AI configured to provide personalized education to the users may be achieved through orchestrated experiments. The training data (or user data) may be acquired or received from an academic data score (i.e. online or external database) for data extraction and modeling training by the system of the present disclosure. There may be two aspects to the model training pipeline 250. Prior to the training of the model, data management may be conducted to ensure uniformity, usefulness, and effectiveness of the data used to train the composite AI model. The data management process may comprise the steps of data processing and validation, exploratory data analysis, and feature engineering, as depicted in FIG. 2b. Data processing may comprise but is not limited to the sorting and reformatting of the user data and will be described in more detail herein. Exploratory data analysis may refer to the analysis of data to determine one or more characteristics relevant to the user or provided education content. Feature engineering may comprise feature extraction, dimensionality reduction, and neural representation and will be described in more detail herein.

The “managed” data may be subjected to a hyperparameter tuning aspect of the model training pipeline 250. According to an embodiment of the present disclosure, hyperparameter tuning may describe the process of identifying a set of optimal parameters where the parameters are values that defines the model or architecture of the composite AI model (i.e. controlling the learning process of the AI composite model). As depicted in the flow diagram of FIG. 2b, the hyperparameter tuning process may comprise the steps of model training, model evaluation, and model validation. The model is first trained using the processed data which has been subjected to the step of feature engineering. The trained model may also be evaluated and validated. Based on or using the results of model validation, the composite AI model may undergo additional training until the resulting model is satisfactory and is suitable for providing personalized education to users. this process can be performed by, for example, using the outputs of model validation (i.e. validated model) as an input for further training to improve the capabilities of the model. This process may be repeated until the model passes one or more tests during validation. The training pipeline 250 may produce one or more trained and validated AI models. The AI models may be in the form of computer code and may be stored as source code in a source repository such as GitHub. Iterations of the AI model may be stored. Alternatively, only the final validated model may be stored.

According to an embodiment of the present disclosure, the model inference pipeline 260 may be an entirely automated machine learning pipeline. Functionally, the model inference pipeline 260 may comprise an automated machine learning pipeline similar to the model training pipeline 250. In short, batch data may be obtained from one or more data store. The received data would undergo data processing and validation and feature engineering, described above. Model inference pipeline 260 may also comprise steps corresponding to hyperparameter tuning. In one embodiment, the processed data may be used for the fine tuning of the composite of the AI model (i.e. further model training). The model being tuned may be a model received from the deployment pipeline. For example, the model may be in the form of code stored in the source repository. The source code may be for a model that has been previously validated in the model training pipeline 250. The tuned model can undergo model evaluation and validation, as described in relation to the model training pipeline 250, and repeating the process of tuning, evaluation, and validation as required to produce suitable models for providing personalized education. The fine-tuned model may be stored as source code in a source repository and/or a model repository. The model repository may be configured to update the system by, for example, using the newest iteration fine-tuned model. The model can be deployed in short cycles automatically through continuous delivery to more seamlessly and efficiently update the system of the present disclosure. By using the Ai model, the system of the present disclosure can make predictions and inferences, which are used to provide personalized education for the user as the output. Further, the model is also able to make predictions using live or real-time data directly obtained from the academic data store to provide personalized education to the users that is adjusted to and for the user in real-time.

According to an embodiment of the present disclosure, the system may receive user feedback to the provided personalized education. The system may use the user feedback and additionally other user data to further improve the AI model in real time through the model inference pipeline 260. For example, the user feedback may be used for monitored based on one or more metrics (i.e. satisfaction tracking and engagement tracking) to determine if the is satisfied with the provided personalized education. These metrics may be validated. If the result of the validation is that that the model and by extension the provided personal education is inadequate for the user, the model inference pipeline 260 may trigger continuous training for the AI model. In continuous training, the user feedback may be used as input data for the automated machine learning pipeline in that the data may be processed, subject to feature engineering, and be used for model tuning. The deployment of this feedback loop can continuously improve the AI model in real-time in order to provided the most suitable and tailored education for the user to ensure satisfaction. Furthermore, data from the model inference pipeline 260 may be provided to and stored on an experiment tracking database or metadata store.

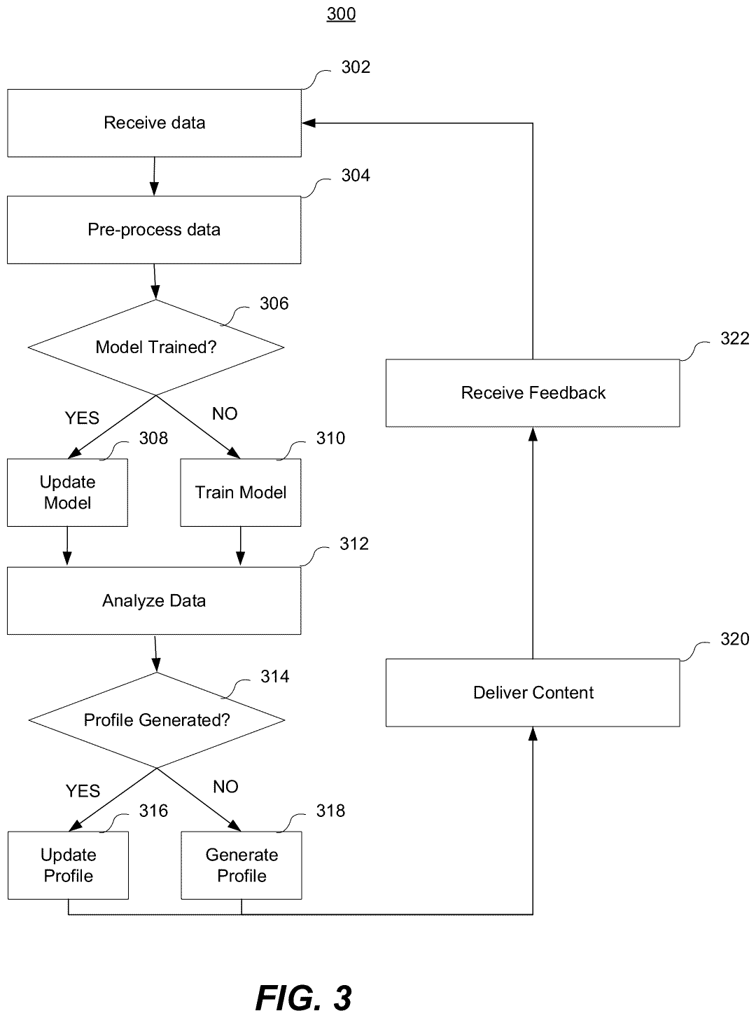

FIG. 3 depicts a flow diagram for providing real-time adaptable personalized education to a user.

The system and method 300 may comprise acquiring data associated with an user (302). The data may be obtained from a variety of different sources, including and limited to: online databases, internal databases, external databases, academic databases, IoT devices, NFC devices, user feed back and response (i.e. by interacting with an interface of the system). The received data may comprise academic information. Academic information may include one or more of: diagnostic test results, academic records, and test scores. The received data may also comprise non-academic information. The non-academic information may comprise one or more of: personal data, emotional data, and physical data. More specifically, the non-academic information may comprise one or more of: facial expressions, body language, voice inputs, heart rate, sleep cycle, and physical actions. The system may proceed to process or pre-process the received data (304). Data processing may comprise one or more of: sorting, filtering, homogenizing, formatting, weighting, dimensioning, feature identification, and feature extraction. The processed (pre-processed) data may also be fed to and ingested by a composite AI model or one or more AI models.

According to an embodiment of the present disclosure, the system may choose one of two options based on if there already exists a composite AI model or one or more AI models (306) that is configured to provide personalized education to the user. This stage my be referred to a the model training or model updating stage. If a model is not available for the user (NO at 306), for example, if the user is newly registered or if a new model is required, the proceed data is used to train a AI composite AI model or one or more models (310). Alternatively, if there is an existing model for the user (YES at 306), the existing AI model(s) would be analyzed, validated, and updated (308) based on the processed data to improve the ability of the model(s) to provide personalized education and better tailor the education based on the user. It should be noted that the processed data may be used directly as input for training the AI model(s). It is also possible that the processed data is used as a basis for updating or training the model(s). That is, the processed data is not directly used and rather that the model(s) are trained/updated based on the processed data. Further, a combination of direct and indirect data use are also possible. The processes of updating and training AI models have been described previously and will be described further herein.

According to an embodiment of the present disclosure, the trained/updated AI model may analyze or process the received data (312). This stage may be referred to as model inference stage. The data may be analyzed to extract patterns and provide insights. The analysis of data may comprise the steps of data processing, sorting, formatting, and normalization. For example, the data may be categorized and processed into suitable formats for one or more component models of the composite AI module where different types of data are processed by different models. The model(s) may also weigh the received information as well as identify important features. Based on the weighting and feature identification, the model(s) may be ale to interpret the data in educational terms. For example, personalized education profile may comprises academic attributes of the user and/or non-academic (physical, emotional state) attributes of the user. Academic attributes may comprise one or more of: educational level, knowledge, academic strength and weakness, and academic progress. The system may choose one of two options based on if there already exists a personalized education profile for the user (314) that captures the state of the user in education terms. If a personalized profile is available for the user (YES at 314), for example, if the user is an existing user that has previously used the system or is currently using the system, the system may update the user profile based on the analysis of the AI model(s). Alternatively, if there is no personalized profile for the user (NO at 314), for example, if the user is a new user that has just begun to use the system, the system may generate a personalized profile for the user based on the analysis of the model(s) such that their information and current state can be represented in educational terms. The system may generate and deliver personalized education content to the user (320) based on the education profile of the user.

It should be noted that while the diagram depicts the generation/update of a personalized profile, there may not be an explicit profile for the user. That is, the information related to the user that would normally be comprised in the personalized profile may be directly applied to the generated education content. Alternatively, such information could also be tracked in relation to one or more education content that is generated. Alternatively, the model(s) may analyze the user data and determine one or more factors, attributes, or information that is related to or may affect the education of the user. The determined information may be used to directly generate personalized education content for the user without first generating or updating a user profile. The delivered content may comprise one or more of: lessons, activities, simulations, experiments, and questions. As one might infer from FIG. 3, when the user profile is updated, the delivery content may also be updated in response. The system may also, with the aid of the AI model(s), modify the personalized education based on the user profile by, for example, adjusting a difficulty of the delivery content, providing targeted delivery content, adjusting the delivery mode, adjusting the interaction style, changing the delivery pace, and customizing breaks.

According to an embodiment of the present disclosure, the response and feedback of the user to the delivered personal education may be measured, tracked, and received (322). The response and feedback may comprise academic information and non-academic information as previously described. The feedback may also comprise the user's results and performance in response to the content that was delivered, for example, the correctly (or incorrectly) answering questions (on a test) or successfully completing an activity or experiment. In an embodiment of the present disclosure, the user feedback may be monitored as an user's emotional state or cognitive state. For example, the system may monitor one or more metrics relating to the emotional state of the user, the metric comprising one or more of: level of focus, engagement level, stress, enthusiasm, and confusion. The system may also monitor cognitive metrics comprising one or more of: response time, interaction duration, response accuracies. The information collected as user feedback may be used by the system to improve the personalized education and/or AI model(s). As depicted in FIG. 3, the feedback may be used as input data to the models. That is, the system may comprise a feedback loop that continuously tracks information relating to the user in short cycles or real-time, which may be used by the system to update AI models, personalized profile, and delivered personalized education content. This may ensure that the system is always providing the most optimal and suitable education depending on the state and needs of the user.

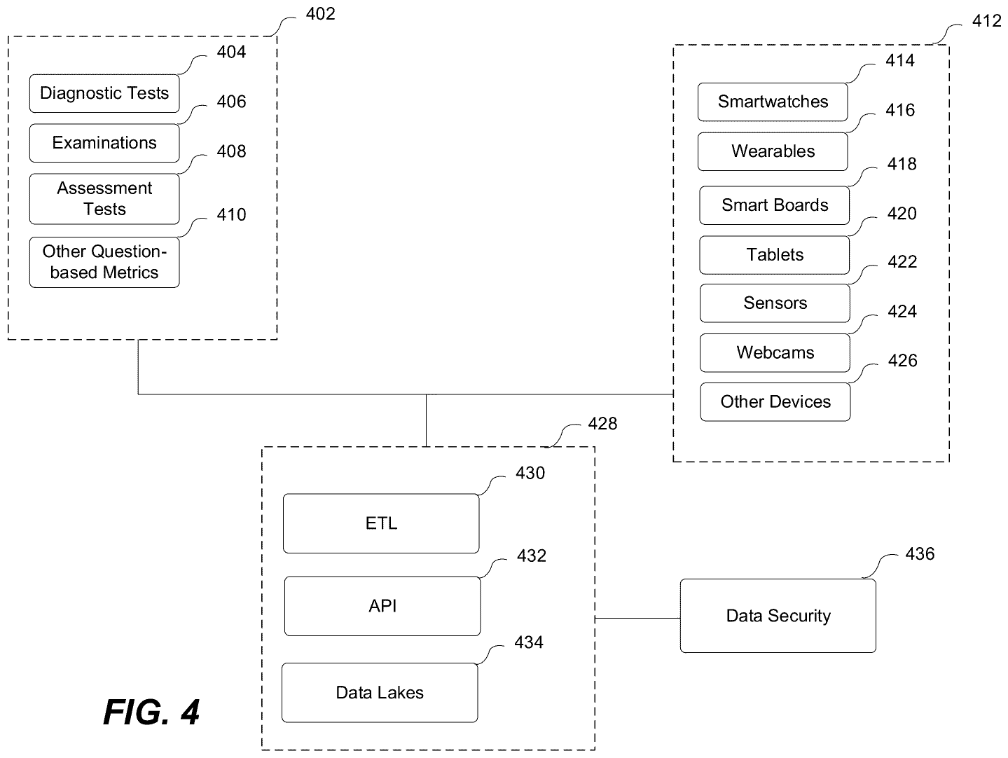

FIG. 4. shows a representation of the sourcing and integration of data for a system or method configured to provide adaptive personalized education. As depicted in FIG. 4, in the era of digital transformation, data may be gleaned from a plethora of sources in order to gain unique insights into a student's learning journey and well-being rather than limiting data to educational data confined to test scores or classroom participation metrics.

As shown in FIG. 4, the system for providing personalized education 428 may acquire different data from a variety of different sources. According to an embodiment of the present disclosure, the system may acquire data in the form of traditional education metrics 402. Traditional education metrics may be in the form of or obtained from one of more of diagnostic tests 404, examinations 406, assessment tests 408, and other questioned based metrics 410. These traditional metrics may use questions and the accuracy of responses to said questions to gauge the level of knowledge that a student have in an area of study. The system may receive traditional metrics data 402 from external database over a communication network. For example, the system may retrieve previous test scores in one or more subjects from storage database of an academic institution. The system may also obtain assessment results from the database of an education board. As another example, internal test results from a company may be obtained by the system to be analyzed. The system may also have access to traditional education metrics 402 that are as a result of internal tests provided by the system to the user. The diagnostic tests 404, examinations 406, assessment tests 408, and other questioned based metrics 410 may be provided to the students as a series of questions. The questions may be multiple choice questions, matching questions, or questions requiring numerical or short answers. Certain questions may also require longer text answers. The system may receive data of traditional education metrics 402 in the form of scores, scores breakdown, or as raw data comprising the questions and answers themselves.

Diagnostic tests 404 may be tests designed to determine a level of understanding of certain topics or areas. The diagnostic tests may be designed or provided by the system, which may be a general test application to all users or a customized test for a specific user. Alternatively, the system may receive the results of external diagnostic tests completed by the user. It should be noted that the system may analyze diagnostic test results using statistical methods and machine learning algorithms to identify strengths, weaknesses, and learning gaps. Examinations 406 may be academic examinations or external examinations taken by the user. In some embodiments, examinations 206 may contain longer written responses. The system may applying natural language processing (NLP) and sentiment analysis using LLM's as to process written answers and gauge the correctness of responses, depth of understanding, and concept application. Assessment tests 408 may be external assessment tests and standardized tests such as the Scholastic Assessment Test (SAT), the Chartered Financial Analyst (CFA) exam, and the Common Final Examination (CFE). The system may be able to integrate the tests and test results with the system. By analyzing the user's assessment test results, the system may be able to provide benchmark data as well as calibrate the delivered personalized education against global standards.

According to an embodiment of the present disclosure, the system may acquire data in the form of IoT device data 412. IoT device data 412 may be received from smartwatches 414, wearables 416, smart boards 418, tablets 420, sensors 422, webcams 424, and other devices 426 including NFC devices, computers, and mobile phones. The IoT devices may be configured to communicate with the system over a communication network such as the internet, NFC, or Bluetooth. Examples of IoT devices may include FitBit, Apple Watch, and Garmin devices, which may be implemented as smartwatches 414 or wearables 416. The system may capture continuous streams of IoT device data 412 such as physical activity, heart rate, and sleep cycles. The captured data may be used to infer one or more states or attributes of the user such as physical and emotional wellbeing. The system may additionally conduct advanced signal processing techniques to preprocess this data and make it suitable for neural network ingestion. Devices such as smart boards 418, tablets 420, and sensors 422 may be classified as classroom IoT devices. These devices may be integrated or incorporated as a part of the classroom setting or environment. The system can monitor the data from these devices to determine engagement levels, participation rates, and environmental conditions conducive to learning. It would be appreciated that these device may also be a medium for receiving student feedback, for example, students can respond to questions using the interface of other devices 426 such as a mobile phone or computer. Further, the system may be built using open-ended architecture, with regular updates to the device integration components to allow for the addition/integration of new devices as they become popular or relevant.

The system of the present disclosure may comprise a modular data integration framework 428. The framework 428 may comprise a Extract, Transform, Load (ETL) component 430. The ETL component 430 is configured to extract data from its source, to transform the data into a suitable format (for use in the system), and to be loaded into the data repositories. The process may also be used for harmonizing diverse data formats (i.e. IoT/NFC devices data, academic results, external assessments) into a unified system. That is, the ETL (Extract, Transform, Load) process may be a crucial data integration process that allows the system to collect data from multiple upstream sources, convert it into a unified format, and load it into the Data Lakes, for facilitating strategic decision-making. The framework may also comprise an API and middleware component 432 configured to integrate and accept the various data acquired, for example, traditional education metrics 402 and IoT device data 412. The API and middleware component 432 may comprises processors or programming configured for smooth data flow into the system. It would be appreciated that API Integration allows the various components to communicate and exchange data. The system may also comprise a data lake and storage component 434 to store the processed and unprocessed data including traditional education metrics 402 and IoT device data 412. The system may receive a very high volume of data in a variety of formats. To better facilitate efficient storage and rapid data retrieval for both structured and unstructured data, data lake and storage component 434 may leverage scalable data lakes, which can store data in its native format as well as have adaptable volumes that can adjust the storage based on the volume of data. It should be noted that the ETL component 430, API and middleware component 432, data lake and storage component 434, or portions of said components may be both implemented as a part of the composite AI model or outside of the AI model framework.

The framework may also comprise a data security component 436 configured to maintain data integrity and privacy for the system. As an example, the system may receive education data that is considered sensitive, or user data where said user is a minor. These data are private and should be highly secured. The data security component 436 may comprise stringent data encryption mechanisms, differential privacy techniques, and anonymization protocols to ensure data security, The data security component 436 may operate on data before the system receives and transmit user data such as traditional education metrics 402 and IoT device data 412. The data security component 436 may also operate on data transmitted between various components of the system for additional security. Further, the data security component 436 may undergo regular audits, access controls, and compliance with global data protection regulations (for example, GDPR or CCPA) such that student data remains secure and private at all times. The data security component 436 may also implement role-based access control (RBAC) to ensure that only authorized personnel can access specific data segments.

It would also be appreciated that the framework 428 is modular in nature that that components may be added or removed as required. The components described with regard to the framework 428 may work independently or cooperatively. The data received by the framework and processed data (by any one of the components) may be transmitted between individual components for further processing. Furthermore, operations involving any components may be conducted in any order and is not limited to the flow depicted in FIG. 4.

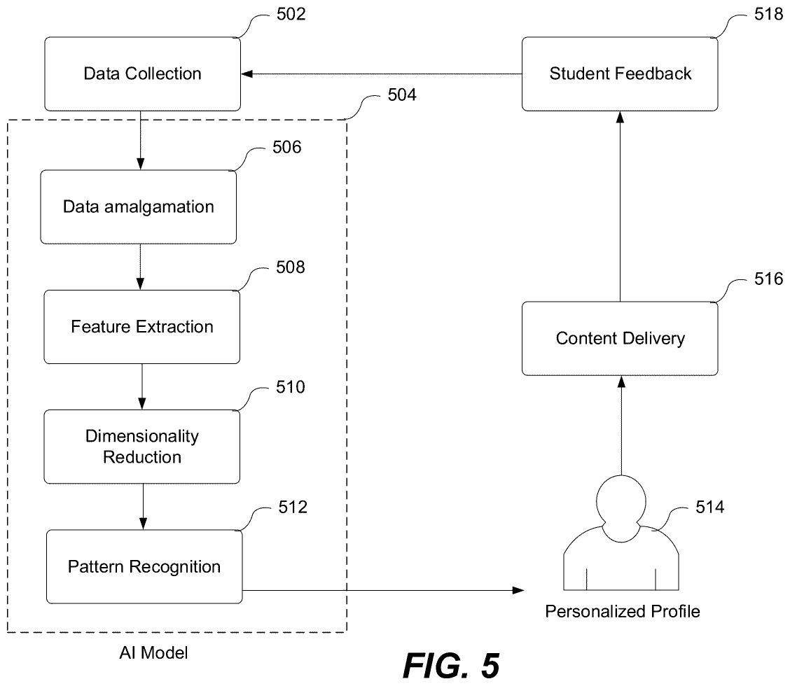

FIG. 5 shows a flow diagram for holistically profiling users of a system configured to provide adaptive personalized education. To create a multi-dimensional representation of each student, capturing not only academic achievements but also personal habits, preferences, emotional states, and physical well-being, the system may be configured to generate and update a comprehensive personalized education profile for each user.

According to an embodiment of the present disclosure, the system and method for generating and updating a personalized profile 514 of a user is provided. As depicted in FIG. 5, the system may receive user data (502) to be processed and analyzed by a composite AI model 504 configured to generate the personalized profile 514 and to delivery content 516. The acquired data and method for acquisition have been discussed previously with regard to FIGS. 2-4. It would be appreciated that the composite AI model 504 may be one or more algorithms or one or more individual AI models working independently or cooperatively. The AI model may be configured to conduct one or more of data amalgamation 506, feature extraction 508, dimensionality reduction 510 and pattern recognition 512. Additionally, the AI model 504 may also be responsible for generating and updating the personalized profile 514 and delivered content 516. Further, it would be appreciated that the aforementioned processes may be performed concurrently, in the sequence as described below, or in a different order.

As shown in FIG. 5, the AI model 504 performs a process of data amalgamation 506 where the system may aggregate and fuse the received data. During data amalgamation 506, the AI model 504 may perform multi-source data assimilation. That is, the AI model 504 may employ various data integration techniques to collate data from diverse sources such as wearables, academic databases, IoT devices, NFC devices, and digital interactions, as described previously. Concurrently or afterwards, data amalgamation 506 may also comprise performing amalgamation of heterogeneous data using one or more fusion algorithms such that different data types and structures are harmonized into a consistent format. The AI model 504 may also conduct feature extraction 508 on the amalgamated data. During feature extraction, the AI model 504 may identify and extract relevant attributes or characteristics from raw or processed data. For Example, the AI model 504 may identify patterns in sleep cycles, physical activities, or recurring sentiments in online interactions as important characteristics to be considered for the personalized profile of the user. The AI model 504 may also perform dimensionality reduction 510 on the received data. For example, the AI model 504 may use techniques including Principal Component Analysis (PCA) and t-SNE to reduce the data complexity and to retain only the most significant features for profiling. This can improve the efficiency and effectiveness of the system in profiling users and providing personalized education, particular in view of the large amounts of data that must be processed. The AI model 504 may also perform pattern recognition 512 on raw or processed data to determine neural representations. The AI model 504 may comprise deep learning architectures, for example autoencoders, to capture high-dimensional data's nuanced patterns. The system may use neural representations as foundational vectors for establishing the dynamic profiling system.

According to an embodiment of the present disclosure, the analysis result of the AI model 504 from the above described process may be used to generate the personalized education profile 514 for the user. Alternatively, the model may, in a case where the user has an existing profile 514, determine based on the analysis result to update (or not to update) the personalized profile 514 where the updates to the personalized profile 514 is based on the analysis result. The personalized profile 514 may comprise academic attributes of the user comprising one or more of: educational level, knowledge, academic strength and weakness, and academic progress as well as non-academic attributes that may impact the education of the user such as emotional and physical wellbeing. More specifically, the aforementioned processes may serve to provide a comprehensive emotional and cognitive profile of the user. To produce a more complete and holistic personalized profile 514, the user profile 514 may include results of sentiment analysis and cognitive load estimation on the user, which may affect their ability to learn. For example, during the above described process, the AI model 504 may have analyzed one or more of: written content, online interactions, and voice inputs (if permissions are given) to gauge emotional states such as stress, enthusiasm, or confusion as a part of sentiment analysis. As another example, the AI model 504 may estimate the cognitive load on students based on interaction times, response accuracies, and other metrics. These metrics may be used to tailor content delivery rate, described further herein. The profile 514 may also include information such as the student's habits and tendencies that may affect their learning experience.

The system may, with the aid of the AI model 504, tailor education content 516 provided to the user based on the user profile 514. The system may provide customized content comprising one or more of: lessons, activities, simulations, experiments, and questions to the user based on their profile (i.e. based on their level of knowledge, strengths, and weaknesses). Further, the system may also adjust one or more of: content delivery modes, pacing, interaction styles, and even assessment methodologies based the personalized profile 514. As shown in FIG. 5, the system of the present disclosure comprises a continuous profile update mechanism. That is, the user response and feedback 518 to the delivered content 516 may be used to further improve the personalized education provided by the system. For example, direct student feedback, as well as inferred feedback from engagement metrics, may be continuously fed in real-time into the system or AI model 504 as input data to be processed as shown in FIG. 5 and described above to ensure real-time profile updates. By analyzing these feedback, the AI model 504 may also be able to update the profile 514 and delivery content 516 in real-time.

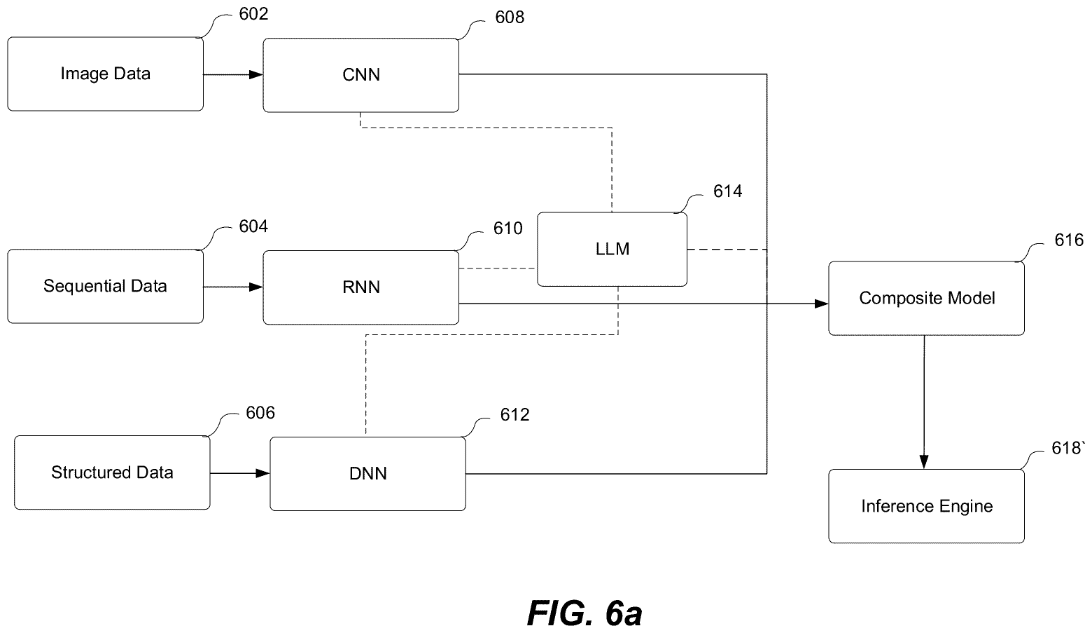

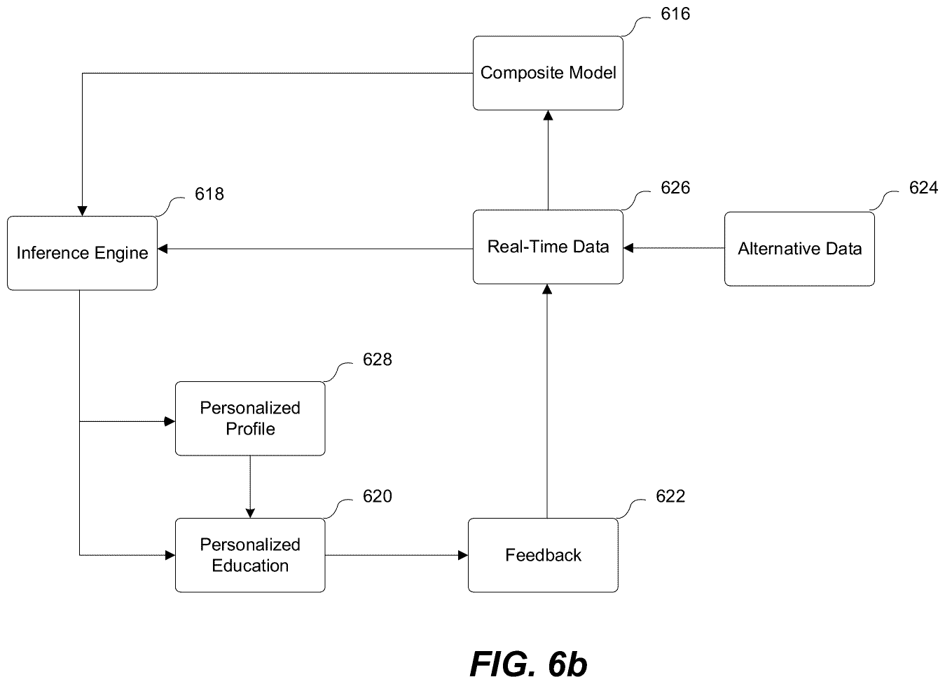

FIG. 6a shows a flow diagram for training a composite AI model of a system configured to provide adaptive personalized education.

According to a broad aspect of the present disclosures, the data for training the composite AI model may be sorted into three streams: image data 602, sequential data 604, and structured data 606, as depicted in FIG. 6a. Each type of data may contributes to the overall learning and analysis ability of the inference engine 618, which is supported by the composite AI model 614. The data for training may be sourced externally or captured from users over a period of time. The composite AI model 616 may comprise one or model individual AI models or neural networks working independently or cooperatively. Examples of the AI models may include CNN 608, RNN 610, DNN 612, and LLM 614. Each of the AI models may be configured to process and analyze one or more specific types of data. As such, specific types of data may be required to train each of the CNN 608, RNN 610, DNN 612, and LLM 614.

CNN 608 may describe a type of deep learning algorithm prevalently used for visual task processing. It can possess a unique architecture to learn features autonomously, which can make CNN 608 well suited for image recognition, including patterns and objects. In particular, CNN 608 could be utilized to analyze educational resources or tools that rely on visual input. For instance, it can recognize specific gestures a learner makes in a virtual reality science lab and translate them into applicable actions.

As depicted in FIG. 6a, the CNN 608 may be trained using image data 602. Image data 602 may be data in the form of images and videos. It would be appreciated that image data 602 may be received from IoT devices, NFC devices, and other data sources such as CCTV video feed and cameras including standalone webcams and webcams of mobile devices, laptops, etc. in a further embodiment of the present disclosure, the CNN 608 may be trained with image data 602 that is merged with documented emotional state of the students. The data of emotional state may be derived using the AI model (or a different AI model) previously or received as user input. Through training using image data 602, the CNN 608 may be able to determine emotional/mental wellbeing and state of the users or improve its ability to determine said wellbeing and state. For example, the CNN 608, may be able to, through training, decode minute variations in facial expressions or body language that are associated with understanding or stress. Such capabilities may better enable real-time modification of content delivery by adjusting the delivery content based on the emotional state of the user (i.e. offering breaks when the users are stressed). In some embodiments of the present disclosure, the CNN 608 may be trained and used in conjunction with LLM 614, for example, if text-based data are to be processed, analyzed, or used by training (i.e. the documented emotional state of students).

RNN 610 may describe a neural network that can remember previous inputs in series of data, which can make it particularly useful for sequential data analysis. This property allows RNN 610 to capture temporal dependencies, which standard neural networks might miss. In particular, RNN 610 could analyze a student's learning progression over a series of lessons from which it may point out recurring struggle points and subsequently adjust the courseware to address these issues.

As depicted in FIG. 6a, the RNN 610 may be trained using sequential data 604. Sequential data 604 may be timeline data that documents the interactions of the user with the system over time. Sequential data 604 may also be data of the user's academic progress, such as test results over a period of time. Sequential data 604 may be obtained from external sources such as databases of education institutions (i.e. exam results over time) or may be data associated with an user that is tracked and stored by the system (i.e. how user response to delivered content or questions over a period of time). Through training, the RNN 610 may be able to ascertain shifts in learning pace and engagement levels or improve its ability to do. For example, the RNN 610 may monitor learning pace and engagement level by comparing the tendencies (i.e. frequency and type of interactions) of the user with historical actions or tracking the progress of the user in learning a certain topic compared to a baseline progress or historical progress. Such capabilities may better enable the system to recommended breaks and introduce alterations in content provision. In some embodiments of the present disclosure, the RNN 610 may be trained and used in conjunction with the LLM 614. For example, the LLM 614 may be utilized in the training of RNN 610 to process and analyze text-based timeline data.

DNN 612 may describe a neural network with multiple hidden layers of nodes that transform input data. As an advanced technique in Machine Learning, DNN 612 can mimic the human brain's operation to distinguish and classify information. Its structure can allow it to manage complex, personalized learning tasks including the development of a student's study plan. For example, DNN 612 can process varied data, such as a student's grades, study habits, and learning preferences, to generate a tailored course of study.

As depicted in FIG. 6a, the DNN 612 may be trained using structured data 606. Structured data 606 may comprise one or more of: academic records, exam scores, benchmark/diagnostic test scores, and a history of academic inputs over time. Structured data 606 may be obtained via IoT devices, NFC devices, or websites. For example, the system may track and stores the interactions of the user with the system as well as their past exam and test scores. Structured data 606 may also be obtained from external sources such as databases of education institutions. In some embodiments of the present disclosure, the DNN 612 may be trained and used in conjunction with the LLM 614 (for example, to process and analyze text based-data inputs). It should be noted that the difference between structured (tabular) data and sequential (text) data is the way these data types are organized, used and processed. Structured data is often organized in rows and columns, in a highly defined and pre-arranged manner. In contrast, sequential (text) data is an example of unstructured data where the arrangement is less defined, more complex, and usually contains text, images. Through training, the DNN 612 and LLM 614 (when applicable) may be able to better understand each user's capabilities and limitations regarding their knowledge and understanding of different topics. As such, the system may be able to adjusting content complexity, delivery speed, and reinforcement methods accordingly.

Further, the LLM 614 may also be trained with a variety of data as described above and additionally knowledge from books (i.e. from an external database or obtained online) or from chat conversation data (i.e. from the IoT/NFC devices or interactions with the system). In particular, the LLM 614 may be trained with an emphasis on sequential data 604. By incorporating the LLM 614, the system may be able to understand the context better and generates the required information for students learning.

The combination of CNN 608, RNN 610, DNN 612, and LLM 614 form the composite AI model 616, which drives the inference engine 618 that makes predictions and identify patterns in student behaviour. By utilizing the composite AI model 616 to analyze the user in both academic and non-academic aspects, the inference engine 618 can provide better personalized education for the user. Moreover, the training process may be governed by heuristic search algorithms, which may tweak the model parameters to boost the customization ability of the composite AI model 616 and therefore the system itself. For example, the methods like RMSProp or Adam may be employed during gradient descent to manage weight updates. Further, even when training is completed, the composite AI model 616 may be configured to absorb additional data inputs. The composite AI mode 616 may analyze additional data as standalone inputs and in correlation with learned patterns from past data sets to maximize efficiency and improve adaptability and learning capabilities. As such, the system may be able make useful predictions and to adapt a student's learning pathway in a highly personalized manner.

FIG. 6b show a flow diagram of updating a composite AI model of a system configured to provide adaptive personalized education. As described previously, the system and composite AI model may be configured for continuous learning and adaptation, by for example, updating the model using real time user data in a feedback loop. In particular, the system may integrate a feedback loop mechanism as depicted in FIG. 6b to obtain insights from the user's interactions with the system, their performance metrics, and feedback from other sources such as teachers and parents. This continuous learning mechanism can refine personalization algorithms progressively, tuning the student's learning experience, engagement, and overall outcome over time.

As shown in FIG. 6b, the inference engine 618 configured to make predictions and identify patterns may be able to, using the analyzed insights such as the user's current level of knowledge, mental and physical wellbeing, generate a personalized profile 628 for the user, as described previously. The personalized profile 628 may be used as a reference or basis to provide personalized education 620 in the form of generation of customized education content for the user. Alternatively, the inference engine 616 may directly use the determined insights to provide personalized education 620 to the user without generating or utilizing the user profile 628. The system may receive one or more user feedback 622 in the form of user's response to the personalized education 620 (i.e. answers to questions), interactions with the system, or monitored data from IoT/NFC devices. The user feedback 622 is tracked and monitored as real time data 626, which can be used as additional inputs to train or further update the composite AI model 616. Further, real time data 626 may also comprise additional data such as response from teachers and parents (for example, received by the system through IoT/NFC devices) or data from external sources such as online databases (i.e. the latest exam scores of the user). It would be also appreciated that the composite AI model 616 may also process and analyze real time data 626 to identify features and patterns to be further proceed by the inference engine 618 as to make predictions and inferences in education terms. The inference engine 617 may accordingly update the personalized profile 628 and personalized education 620 based on the predictions and inferences. In some embodiments, the real time data 626 may be directly processed by the inference engine without updating the composite AI model 616. By following this feedback loop, the system may be able to better provide personalized education for the user by continuously providing the most suitable and tailored content. Moreover, the feedback loop may also ensure that the composite AI model 616 is trained to be most suitable to identify changes in the students behaviour and learning patterns such that approximate adjustments can be made in real time. The updates may be made incrementally such that the updates can be made without retraining the models.

Further, it should be noted that the system also leverages transfer learning. Transfer learning may refer to a machine learning approach where a pretrained model is used on a new problem. The idea is to store the knowledge gained while solving one problem and applying it to a different but related problem, which may enable the model to apply the knowledge acquired in one setting to another similar context. This feature of the composite AI model 616 may enhance the learning process when dealing with new students or subjects, since the model leverages insights derived from previous data. Furthermore, reinforcement learning may be utilized by the system, which can allow the model to iteratively learn optimal decisions. For example, as the system presents content to the learner, it measures the student's reactions to diverse styles and adjusts the learning pathway accordingly to achieving an optimum balance between challenge and comprehension.

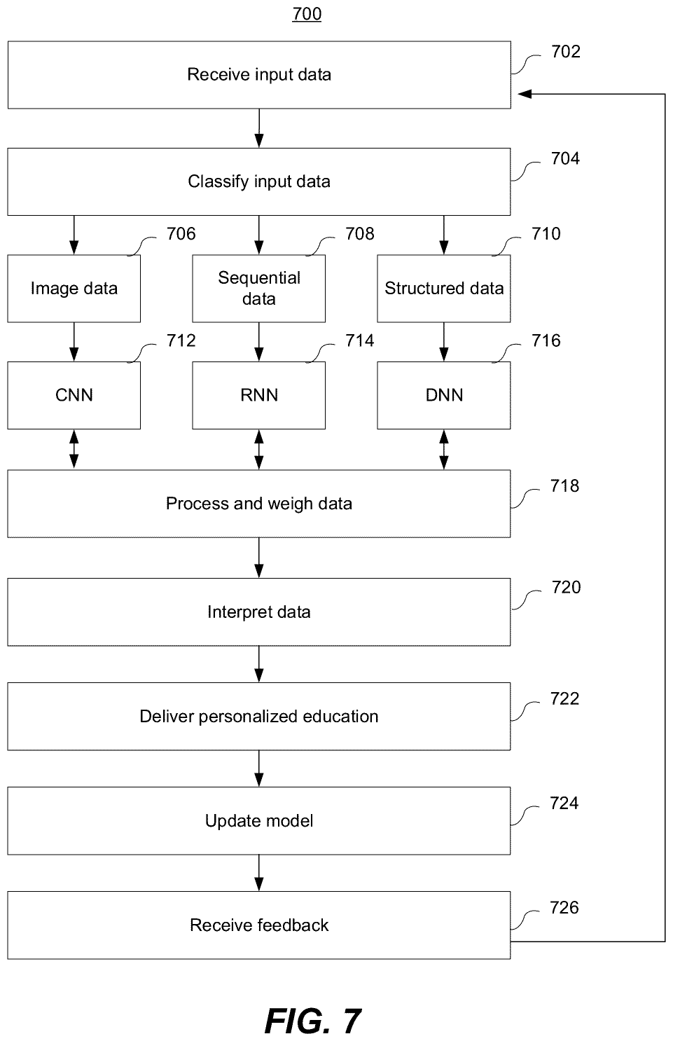

FIG. 7 shows a flow diagram for a model inference system or method 700 configured to provide adaptive personalized education using a composite AI model. Model inference may refer to the prediction stage when the composite AI model is used to make educated guesses or extract patterns from new input data. For example, the algorithms of the system may provide real-time, personalized pedagogical insights and recommendations based on the data inputs from learners.

According to an embodiment of the present disclosure and as depicted in FIG. 7, as the user interact with the system, new input data is constantly generated and received (702). The received data 702 may be obtained directly as user interactions with the system (i.e. through the user interface), through one or more connected IoT devices (i.e. webcams, smartwatch, sensors), NFC devices, or from external sources (i.e. online databases). For example, the received input data 702 may be one or more of the student's academic performance, their engagement level on the platform, recorded facial expressions during certain tasks, or their responses to quizzes and tests. The received data 702 may be classified into one or more types of data (704). According to an embodiment of the present disclosure, the data may be pre-processed following the same procedures used in the model training process. For example. The data may be classified into three categories: image data 706, sequential data 708, and structured data 710. The classified data may be normalized, formatted, and outlined for one or more AI model. The AI models may be one or more of: CNN 712, RNN 714, and DNN 716. As described previously, the CNN 712 may be configured to process image data 706, the RNN 714 may be configured to process sequential data 708, and the DNN 716 may be configured to process structured data 710.

The system may perform forward propagation of data where the CNN 712, RNN 714, and DNN 716 can process and weigh the sorted data (718) cooperatively or independently. At this stage, the AI models may also identify patterns or features from the data that may be included in the personal profile of the user or may affect the user's learning. It would also be appreciated that the processed data from one model can be processed by another model. For example, the order of data processing may be as follows: CNN 712, followed by RNN 714, and followed by DNN 716. More specially, the system may perform: identification of emotional cues by the CNN 712 (i.e. from webcam data), detection of changes in learning progression or interaction patterns by the RNN 714 (i.e. from tracked user inputs on the system interface), and evaluation of academic achievement trends and topical strengths and weaknesses by the DNN 716. In some embodiments of the present disclosure, the system, inference engine, or the AI model(s) may assign weights to certain types of data before or after processing. For example, the CNN 712 may determine that the webcam data is not particularly important and as such assign it a low weighting number. The RNN 714 may determine that user interaction is more important to understand the learning capabilities of the user and as such assign it a higher weighting number than the webcam data. In some embodiments of the present disclosure, the identified features or patterns may be assigned a weighting rather than the type of data. Alternatively, the AI models does not assign weights to the data. Instead, the system may assign a weighting to each type of data (for example, during pre-processing) before the AI models analyze the sorted stat.

The system may make education inferences based on the patterns and predictions made by the CNN 712, RNN 714, and DNN 716. That is, the system will interpret the information produced by the AI models in educational terms (720). For example, the system can update a number value that represents a degree of competency of a user in a subject area by tracking an increase of user test scores in that area. As another example, the system may become aware, through the CNN 712, that the user's engagement has declined (i.e. by tracking the number of interactions with the system or the user's eye movement (away from the interface) or body language). As another example, the system may become aware, through the DNN 716, that the user has an understanding gap in a particular topic through the DNN's identification of recurring mistakes in that topic. Based on the interpretation of data 720, the system may provided personalized education content to the user or adjust the delivered education content to the user (722). That is, while the system may continue to deliver education content for the same topic, the delivery content and format may be adjusted based on the interpretation of the data. For example, when the user's engagement declines, the system may respond with immediate change in content display, layout or includes an interactive component to regain attention. As another example, if the user has an understanding gap in a particular area, the system may respond by providing a review or additional resources for that particular area. In some embodiments of the present disclosure, the system may generate or update a personalized profile for the user for determining the content to be delivered to the user (722).

It should be noted that the system features self-evolving personalization through the updating of the AI model(s). The data of any previous steps may be used to update the AI model(s) (724) after or concurrently to the step the data is generated (i.e. as the processed data is being produced). In particular, while FIG. 7 depicts that the model is updated (724) after the delivery of personalized education 722, the model may also be updated 724 concurrently to or before the delivery of content 722. The system may use user feedback 726 as new inputs which is used to update and improve the AI model(s) 724. User feedback may be any of the user's response academic or otherwise, to the delivered education content, which may be obtained from the interface of the system or through one or more IoT/NFC devices. By tracking and analyzing the user's response to the presented content in real time, the system can evaluates the efficacy of the personalization measures and allow the model to improve its understanding of the user and continuously refine the inference accuracy. For example, the system may notice a pattern where the user has lower engagement when content is delivered using a video format. The model(s) may be adjusted such that content delivery using video is less prioritized and that content are more often delivered with another format such as through activities. As such, the addition of new user feedback in every iteration of the feedback loop depicted in FIG. 7, the system may become more attuned to specific learner patterns. Thus, the system may be able to facilitate a highly adaptive, personalized and responsive education model that caters uniquely to individual user's needs and affinities.

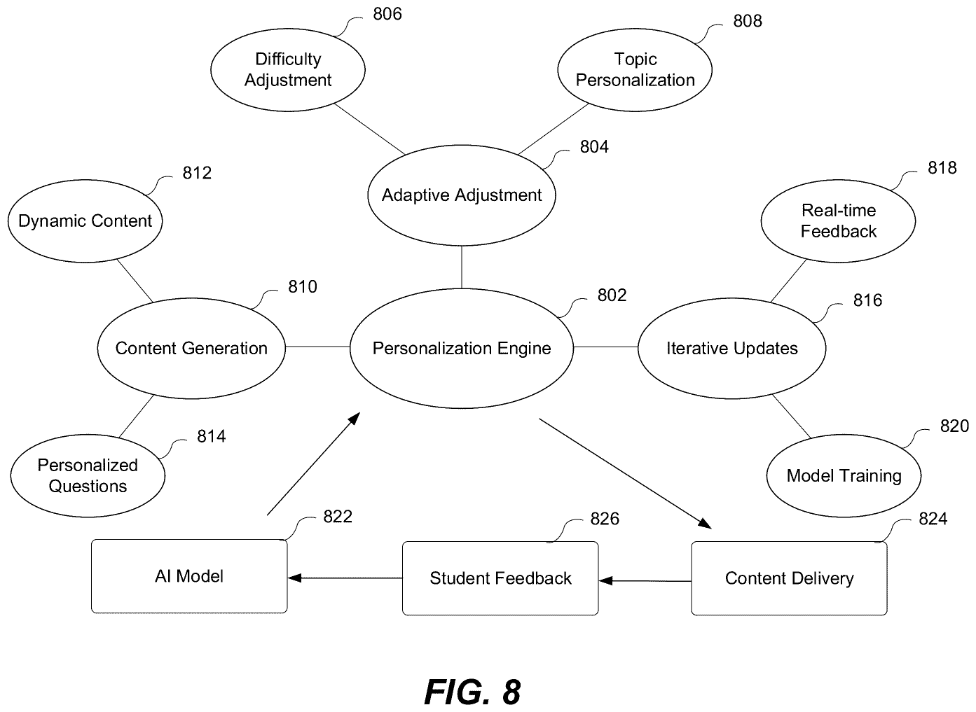

FIG. 8 shows a representation of the content personalization engine of a system configured to provide adaptive personalized education. According to an embodiment of the present disclosure, the system for providing personalized education may comprise a content personalization engine 802 which may can be a modular component configured to generate personalized education content based on information associated with the user. The content personalization engine may be coupled to or in communication with the composite AI model 822, which may be utilized by the engine 802 to generate personalized content. Alternatively, the personalization engine 802 may comprise its own set of algorithms and AI model or models configured for content generation. As described previously, the AI model 822 may analyze user data to find patterns and insights in education terms. These information may be communicated to the content personalization engine 802, which would tailor the education content based on the explicit student data and inferred student traits. The content created by the personalization engine would be presented to the user (824) for viewing once generated. The system would also continuously monitor and track the response and feedback of the user to the delivered content (826). The user feedback 826 would be received by the composite AI model 822 for updating the model and generating new insights and predictions on the education process of the user in real-time. By receiving constantly updated insights and predictions from the AI model 822, the content personalization engine 802 can adjust the delivered education content to the user in real time to provide tailored content that accurately reflect the current capabilities and states of the user such that content and assessments generated by the system align with a student's strengths, weaknesses, and learning journey.

In an embodiment of the present disclosure, the content personalization engine 802 may comprise an adaptive adjustment mechanism 804. The adaptive adjustment mechanism 804 may be configured to personalize and modify the questions generated by the system. The questions may be tests, quizzes, or questions during lessons to facilitate learning. The adaptive adjustment mechanism 804 may utilize dynamic difficulty adjustment 806 and topic personalization 808 to provide personalized questions to the user. Dynamic difficulty adjustment 806 may be achieved by the use of one or more algorithms that is configured to adjust the difficulties of the questions in real-time based on the input data and insights captured by the system and analyzed by the AI model. For example, when a student answers correctly, adaptive adjustment mechanism 804 may incrementally challenges them with more complex questions. Doing so may ensure that the student is always stimulated and engaged. As another example, if a student is struggling and failing to answer questions correctly, adaptive adjustment mechanism 804 may scale down the difficulty and provide the student with questions that reinforce foundational concepts before moving to more advanced topics. Topic personalization 808 may comprise the utilization of the information contained in personalized profile to provided targeted questions. For example, adaptive adjustment mechanism 804 may identify one or more areas of strength and one or more learning gaps of the user based on the profile of the user. Adaptive adjustment mechanism 804 can accordingly generate questions that address (i.e. questions centered around) the learning gaps to reinforcing weak areas. Similarly, questions that expand the boundaries in subjects where the student excels may be provided to stimulate further learning in that subject area.

In an embodiment of the present disclosure, the content personalization engine 802 may comprise a content generation mechanism 810. The content generation mechanism 810 may be configured to generate personalized education (i.e. various forms of lessons) to be presented to the user using LLMs. The content personalization engine 802 may be configured to utilize the LLM of the composite AI model 822 for content generation or may comprise its own LLM for content generation. The content generation mechanism 810 may utilize dynamic content creation 812 and personalized question generation 814 in content generation. Dynamic content creation 812 may be achieved using LLMs configured to generate different types of content for presentation to the user. The content may include explanatory content, examples, and lesson summaries. The content generation mechanism 810 may ensure that the generated content is tailored to the user's learning path, current understanding, and preferences based on user information and profile. Personalized question generation 814 may include the use of LLM configured to generate customized questions for the student. For example, content generation mechanism 810 may generate uniquely designed questions such as visual questions, text-based queries, or problem-solving challenges for the student based on the needs of the student. Further, these questions may be tailored based on real-time user data, for example, determined form the profile of the user.

In an embodiment of the present disclosure, the content personalization engine 802 may comprise an iterative update mechanism 816 configured to perform iterative updates to the generated content based on the feedback of the user. The content personalization engine 802 may directly receive user feedback data or access user feedback data through the user profile. The iterative update mechanism 816 may comprise real-time feedback integration 818 and continuous model training 820. As described previously, the personalization engine may be configured to continuously receive real time direct user feedback or input (i.e. user's engagement or interactions with the system, response to questions, etc.) and implicit feedback (i.e. insights analyzed by the AI model from the user interactions). Real-time feedback integration 818 may comprise the use of these feedback to update the content that is provided to the user or how to provide education content. For example, iterative update mechanism 816 may update its content strategies to optimize the learning experience in real-time. Further, content personalization engine 802 may also facilitate continuous model training 820 of internal engine models or the composite AI model. That is, the underlying AI models may be continually refined to update content generation and question adaptation algorithms based on accumulated student data using, for example, online learning techniques.

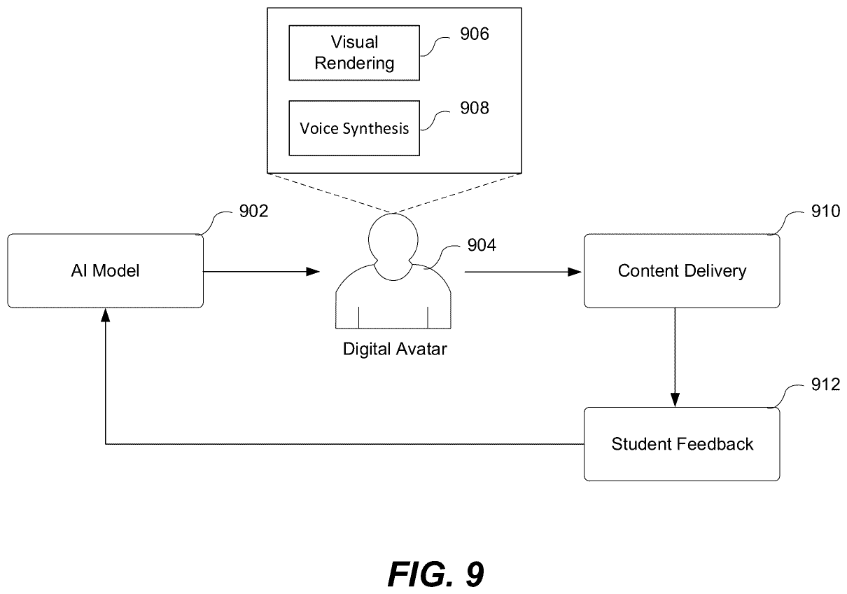

FIG. 9 shows a representation of providing personalized education using a digital avatar. The avatar may be an interactive digital avatar 904 configured to serve as a medium to deliver personalized education 910 to the user. The interactive digital avatar 904 can serve a comprehensive embodiment of the system's teaching persona. The interactive digital avatar 904 may be able to humanize the AI-driven platform, fostering a personal connection and enhancing engagement levels for the user. The interactive digital avatar 904 may be coupled to the content personalization engine such that the content generated by the engine is delivered to the user by the interactive digital avatar 904. Further, the operations and responses of the interactive digital avatar 904 may be support by the composite AI model 902. The composite AI model 902 may update the actions of the interactive digital avatar 904 based on user feedback to the delivered content 912 or the analysis of the user feedback 912 to the delivered education content 910 by the interactive digital avatar 904. Further, the interactive digital avatar 904 may directly receive student feedback and responses to the delivered content and make adjustments to content delivery in real-time as to best support the learning of the user. Additionally, the interactive digital avatar 904 may access the personalized profile of the user to adjust the delivery of content.

The interactive digital avatar 904 may comprise a real time visual rendering module 906 and a voice synthesis and modulation module 908. The visual rendering module 906 may be configured to render a visual representation of the interactive digital avatar 904 on the interface of the system for viewing by the user. The visual rendering module 906 may utilize the framework of SOTA avatar solutions. Furthermore, the rendering module 906 may render interactive digital avatar 904 in real-time, with fluid movements, lifelike facial expressions, and natural gestures. As such, the interactive digital avatar 904 may have added layer of realism to make interactions more immersive for the users. The voice synthesis module 908 is configured to deliver education content to the student in an auditory format (i.e. speech). The synthesized voice may be received by the user through the speakers of the device that the system is being used on, or through headphones or earbuds. The voice synthesis module 908 may comprise various voice generation techniques to enable communication with natural and pleasant voice to facilitate content reception. Moreover, through voice synthesis module 908, the interactive digital avatar 904 may modulate its tone based on the context. For example, the interactive digital avatar 904 can explaining a complex topic when the AI or offer words of encouragement when the AI model 902 determines that the user may be struggling with a particular topic.

The interactive digital avatar 904 may be coupled with the content personalization engine for personalized lesson delivery. The interactive digital avatar 904 may adjust the delivery of the lessons in various ways to best facilitate the learning of the user. Interactive digital avatar 904 may be able to use different dynamic teaching styles and methods based on the characteristics of the student, either from the student profile or from the analysis of the AI model 902. For example, if the system determines that the student is a visual learner, the interactive digital avatar 904 by means of the content personalization engine, may use more graphical representations and simulations. As another example, if the system determines that the student is a kinesthetic learner, the interactive digital avatar 904 by means of the content personalization engine, may suggest hands-on experiments or activities. As described previously and depicted in FIG. 9, the operations of the interactive digital avatar 904 is integrated within a feedback loop where student feedback 912 may be analyzed to improve the content delivery of interactive digital avatar 904 in real time. That is, the interactive digital avatar 904 is capable of real-time adaptation based on continuous assessment of the students engagement through their interactions with the system. For example, if the system determines that a student seems to be losing focus, the interactive digital avatar 904 might introduce a short interactive quiz, tell an anecdote, or even suggest a short break. In a further embodiment of the present disclosure, the interactive digital avatar 904 may comprise a personalized real-time feedback mechanism. Interactive digital avatar 904 may be actively response to the user's interaction with the system beyond the delivery of content. For example, If a student gets an answer right, the interactive digital avatar 904 praises them in a manner they resonate with. As another example, the interactive digital avatar 904 may offer constructive feedback if the student is determined to have gone off-track. These features may help ensure that the student remains motivated and aware.

According to an embodiment of the present disclosure, the interactive digital avatar 904 may comprise a emotional and cognitive resonance module configured to sense the user's emotions as well as to provide contextual interactions with the user. The system may be able to, with the composite AI model 902, analyze user inputs or feedbacks including response times, facial recognition (with appropriate permissions), or voice tonality, to gauge the emotional state of the user. In response, the interactive digital avatar 904 may adjust its teaching methods accordingly, such as by changing the teaching tone, offering feedback, or adjusting the lesson's pace. For example, the system may determine that the user is feeling discouraged due to a reduction in response time and changes in the facial expression. In response, the interactive digital avatar 904 can offer words of encouragement to the user to keep the user motivated. Moreover, the system may, through connections to the communication network (i.e. the internet), have access to and up-to-date understanding of real-world events or other items of interest. To enhance the learning experience for the user and make the lessons more interesting, the interactive digital avatar 904 may make use of the contextual knowledge of things and events outside of the scope of the lessons. For example, the interactive digital avatar 904 may reference real-world events, popular culture, or even a student's personal interests to make the lessons more relatable and engaging such that the student is more receptive to the lessons.

According to an embodiment of the present disclosure. To ensure successful deployment of the system for providing personalized education, several strategies may be undertaken, including infrastructure assessment, modular deployment, and cloud integration. Infrastructure assessment may include the assessment of a infrastructure where the system is to be deployed. Examples of the infrastructure may include user devices and severs (physical or cloud-based) of institutions employing the system. The assessment may include benchmarks for the infrastructure's computational resources, network bandwidth, and storage capabilities to determine if the infrastructure can support the operations of the system. The system is also designed with a modular architecture. That is, components/modules of the system may be added or removed depending the situation as required without comprising the overall function of the system. For example, a small education institution lacking resources may choose to not deploy modules such as the interactive digital avatar or the content personalization engine. Alternatively, these modules can also be implemented incrementally. Moreover, the design of the system of the present disclosure using a flexible and modular architecture/framework can facilitate easier updates and additions of new methodologies and paradigms as well as better integration with current and future learning management systems and educational platforms. It would be also be appreciated that the system of the present disclosure is compatible with various cloud platforms. In particular, the system may be deployed using a combination on-site severs at the deployment location (i.e. a school) and cloud servers or resources using a distributed architecture. Further, the system may be implemented with auto-scaling capability and incorporate load balancing across servers to facilitate increased load on the system without comprising the performance. The hybrid deployment may also improve scalability and availability of the system.

In an embodiment of the present disclosure, the system for providing personalized education may undergo maintenance using one or more protocols. The system may be subjected to continuous monitoring in one or more metrics to ensure functional operation without performance degradation. The monitored metric may include one or more of: performance metrics, system health, and potential anomalies. In a further embodiment of the present disclosure, the system may additionally comprise an automated alert system configured to notify the administrators if potential issues arise. For example, it may be determined that the system health is approach lower threshold. In response, the alert system may automatically transmit a system health alert to the administrator. The system of the present disclosure may also comprise an automated backup system configured to prevent data loss and ensure data integrity. In particular, the system may take data snapshots at regular intervals to store backup copies of important data securely. The system may also implement regular updates and patching to the internal components, framework, as well as integrated third-party components. The patches may address potential security vulnerabilities, optimize performance, and introduce new features. Furthermore, the system may perform regular resource reallocation and optimization to accommodate expansion and facilitate scalability. For example, as the number of users or the amount of integrated data increases, the system may employ a maintenance protocol to reallocation computation resources to user analysis or storage resources to data storage.

As described previously, the system of the present disclosure may be integrated with analytical tools for monitoring system performance through metrics such as user engagement. The monitoring process can be used to direct the optimization of the system to better adapt the needs of the user. Even further, the system may comprise an additional user feedback system configured to accept and solicit explicit and external feedback. For example, the interface of the system may have options or prompts for user to provide feedback to the system itself, which may be used to refine and enhance the features of the system. Non-direct users such as teachers or parents of the users may also be also to provide feedback on the system through one or more channels such as device interface or administrator portals.

The system of the present disclosure may comprise additional framework and components for ensuring security and compliance. Regular security audits may be conducted on the system to ensure data security and system integrity. The results of the regular security audits may be used to identify potential vulnerabilities and mitigation strategies. It would also be appreciated that the system of the present disclosure can be adapted to comply with regional and global data protection standards. Further, regular checks on the system may be performed to ensure that data storage, processing, and transfer protocols adhere to the latest regulations. Moreover, any data utilized by the system both in transit and at rest may be encrypted using industry standard protocols. Additional security measures such as two-factor authentication and role-based access control may also be implemented to secure the data and information of the users.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

It would be appreciated by one of ordinary skill in the art that the system and components shown in FIGS. 1-9 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

1. A method of generating a personalized education profile for a user, the method comprising, using one or more processing devices:
collecting and analyzing user interaction data, wherein the user interaction data includes at least one of behavioral and contextual inputs associated with emotional, visual, or physical cues obtained in real-time as the user interacts with educational content;
executing a machine learning model to generate, based on the collected user interaction data including the at least one of the behavioral and contextual inputs, the personalized education profile; and
dynamically adjusting, in real-time as the user interacts with the educational content, the personalized education profile in response to user performance indicated by the at least one of the behavioral and contextual inputs, wherein dynamically adjusting the personalized education profile includes generating at least one of specific prompts and tailored pathways based on the collected user interaction data; and
outputting digital personalized education content based on the personalized education profile.

2. (canceled)

3. The method of claim 1, wherein the personalized education content comprises personalized delivery content, and wherein the personalized delivery content comprises one or more of: lessons, activities, simulations, experiments, and questions.

4. The method of claim 3, wherein adjusting the personalized education profile comprises one or more of:
adjusting a difficulty of the personalized education content, adjusting a delivery mode, adjusting an interaction style, adjusting a delivery pace, providing customized breaks, and providing targeted delivery content.

5. The method of claim 1,
wherein the user interaction data is collected from one or more of: third-party sources, online databases, and Internet of Things (IoT) devices, and
wherein the IoT devices comprise at least one of: sensors, tablets, wearable electronics, smartwatches, smart white boards, and near-field communication (NFC) devices.

6. The method of claim 1, further comprising:
collecting academic information that comprises one or more of diagnostic test results, academic records, and test scores; and
collecting physiological information that comprises one or more of personal data, emotional data, and physical data, wherein the physiological information is determined from one or more of: facial expressions, body language, voice inputs, heart rate, sleep cycle, and physical actions.

7. The method of claim 1, further comprising:
determining a state of the user based on user feedback, and modifying the personalized education profile based on the state of the user.

8. The method of claim 7, wherein the state of the user is an emotional state or a cognitive state,
wherein the emotional state comprise one or more of: level of focus, engagement level, stress, enthusiasm, and confusion, and
wherein the cognitive state is determined using one or more of: response time, interaction duration, and response accuracies.

9. The method of claim 1, wherein the machine learning model comprises at least one of:
Convolutional Neural Networks (CNN), Recurrent Neural Networks (RNN), Deep Neural Networks (DNN), and Language Models (LLM).

10. The method of claim 1, wherein the personalized education profile is provided to the user with an interactive digital avatar.

11. The method of claim 10, further comprising:
collecting the user interaction data using the interactive digital avatar.

12. The method of claim 10,
wherein the interactive digital avatar is rendered with movements, expressions, and gestures, and
wherein the interactive digital avatar is configured to interact with the user using synthesized speech.

13. The method of claim 10,
wherein the interactive digital avatar is configured to provide feedback to the user, and
wherein the feedback to the user comprises praise or encouragement.

14. The method of claim 10, wherein modifying the personalized education comprises adjusting one or more of: tone, movement, gesture, and expression of the interactive digital avatar.

15. The method of claim 10, wherein adjusting the personalized education profile comprises referencing, with the interactive digital avatar, one or more of: real-world events, popular culture, and personal interests of the user.

16. The method of claim 1, further comprising:
reorganizing the user interaction data into a same format to generate the personalized education profile, and
processing the user interaction data with the machine learning model to produce data that represents the education of the user.

17. The method of claim 1, further comprising:
processing the user interaction data to identify features, reduce data complexity, detect patterns, or a combination thereof.

18. The method of claim 1, wherein the personalized education profile comprises academic and physical attributes of the user, the attributes comprising one or more of: educational level, knowledge, academic strength and weakness, physical wellbeing, and academic progress.

19. A system for providing a personalized education profile for a user, the system comprising:
the one or more processing devices; and
a memory having computer-readable instructions stored thereon, which when executed by the one or more processing devices, configure the system to perform the method of claim 1.

20. A non-transitory computer-readable medium having computer-readable instructions stored thereon, which when executed by the one or more processing devices, configure the one or more processing devices to perform the method of claim 1.
